(19) United States
(12) Patent Application Publication
(10) Pub. No.: US 2026/0091317 A1
(43) Pub. Date: Apr. 2, 2026

(54) GAME SYSTEM, GAME PROCESSING METHOD, AND GAME PROGRAM FOR PROGRESSING THROUGH A GAME USING A CHARACTER

(71) Applicant: GREE Holdings, Inc., Tokyo (JP)

(72) Inventors: Yuki YAMAGUCHI, Tokyo (JP); Kazuyoshi ONODERA, Saitama (JP)

(73) Assignee: GREE Holdings, Inc., Tokyo (JP)

(21) Appl. No.: 19/279,634

(22) Filed: Jul. 24, 2025

(30) Foreign Application Priority Data
Sep. 27, 2024 (JP) 2024-168614

(51) Int. Cl. A63F 13/58

(52) U.S. Cl. CPC A63F 13/58

(57) ABSTRACT

A game system includes one or more processors and a storage that stores a first equipment set associated with a plurality of equipment items. The one or more processors display, on a user device of the user, set item information showing each of the plurality of equipment items associated with the first equipment set, an overlapping equipment marker for distinguishing one or more overlapping equipment items equipped to any of the one or more other characters from among the plurality of equipment items from non-overlapping equipment items not equipped to any of the one or more other characters, and a first input element for applying the first equipment set to the first character. Additionally, in response to selection of the first input element, at least one of the plurality of equipment items is equipped to the first character.

This application claims the benefit of priority from Japanese Patent Application No. 2024-168614 filed Sep. 27, 2024, the entire contents of the prior application being incorporated herein by reference.

### TECHNICAL FIELD

The disclosure of this specification mainly relates to a game system, a game processing method, and a game program for progressing through a game using a character.

### BACKGROUND TECHNOLOGY

In many games, a character operated by a user can be provided with equipment items such as weapons and armor. The user changes the equipment items provided by the character according to the situation of the game. In some games, many equipment items are available. Also, by acquiring new equipment items during game play, more equipment items become available as the game progresses than at the start of the game.

When there are many equipment items that can be equipped, it can be a burden for the user to select which equipment items to equip to the character. To handle this issue, some games provide equipment sets that combine a plurality of equipment items. By specifying one equipment set instead of selecting a plurality of equipment items individually, the user can collectively equip the character with a plurality of equipment items included in that equipment set. For example, “Monster Hunter Now” provided by Niantic, Inc. offers an equipment set called “My Set.” By selecting the desired My Set from a plurality of saved My Sets, the user can collectively equip his/her character with all the equipment items included in the selected “My Set.”

### SUMMARY

### Problem to be Solved

In a game in which a user uses a plurality of characters, when s/he tries to change equipment items equipped by the characters by applying an equipment set, a conflict situation can occur among the characters regarding equipment items included in the equipment set. For example, an equipment item included in an equipment set that is being attempted to be applied to a character may already be equipped to another character. In this case, even if the equipment item is caused to be equipped to any character, the equipment of each character after the equipment set is applied may not reflect the user's intention.

One of the objects described in this specification is to ensure that in a game in which a user uses a plurality of characters, the equipment of each character after an equipment set is applied is in line with the user's intention.

The various embodiments disclosed in this specification may solve or alleviate at least some of the problems described in the “Mode for Implementing Embodiments” of this specification or problems that can be understood from the description of the “Mode for Implementing Embodiments,” instead of or in addition to the above-mentioned problem. When operational effects of an embodiment are described in this specification, the problem(s) corresponding to the embodiment can be understood based on the description of the operational effect(s).

### Means for Solving Problem

The embodiments described in this specification or that can be understood from the description of this specification may be collectively referred to as “this disclosure.” In one aspect, a game system allows a user to progress through a game using a plurality of characters including a first character and one or more other characters different from the first character. A game system according to one aspect includes one or more processors and a storage that stores a first equipment set associated with a plurality of equipment items. The one or more processors display, on a user device of the user, (i) set item information showing each of a plurality of equipment items associated with the first equipment set, (ii) an overlapping equipment marker for distinguishing each of the one or more overlapping equipment items among the plurality of equipment items that are equipped to any of the one or more other characters from a non-overlapping equipment item that is not equipped to any of the one or more other characters, and (iii) a first input element for applying the first equipment set to the first character. Furthermore, the one or more processors are caused to equip the first character with at least one of the plurality of equipment items according to the selection of the first input element.

### Effects

According to the embodiments, in a game in which a user uses a plurality of characters, the equipment of each character after an equipment set is applied can be in line with the user's intention.

### BRIEF DESCRIPTION OF THE DRAWINGS

FIG. 1 is a block diagram showing a game system 1 according to one embodiment.

FIG. 2 is a schematic diagram explaining a process for changing equipment items for characters.

FIG. 3 is a block diagram showing a server provided in the game system 1.

FIG. 4 is a diagram explaining user management data stored in the game system of FIG. 1.

FIG. 5 is a diagram explaining game media management data stored in the game system of FIG. 1.

FIG. 6 is a block diagram showing a user device provided in the game system 1.

FIG. 7 is a diagram explaining equipment management data stored in the game system of FIG. 1.

FIG. 8 is a diagram explaining equipment set data stored in the game system of FIG. 1.

FIG. 9 is a schematic diagram showing an example of an equipment set management screen for a character A. In FIG. 9, an equipment set S2 has been selected.

FIG. 10 is a schematic diagram showing an example of an equipment item change window for changing the equipment items that constitute the equipment set S2.

FIG. 11 is a schematic diagram explaining a process for changing equipment items of a character by applying the equipment set S2.

FIG. 12 is a schematic diagram showing an example of an equipment set management screen for the character A. In FIG. 12, an equipment set S1 has been selected.

FIG. 13 is a schematic diagram showing an example of a switch setting screen for setting whether to transfer an overlapping equipment item to the character A.

FIG. 14 is a schematic diagram explaining a process for changing equipment items for the character by applying the equipment set S1.

FIG. 15 is a schematic diagram showing an example of an equipment set management screen for the character A. In FIG. 15, the equipment set S1 has been selected.

FIG. 16 is a schematic diagram showing an example of a switch setting screen for setting whether to transfer an overlapping equipment item to the character A.

FIG. 17 is a schematic diagram explaining the process for changing equipment items for the character by applying the equipment set S1.

FIG. 18 is a flowchart explaining a process for changing equipment items using an equipment set in one embodiment.

### MODE FOR IMPLEMENTING EMBODIMENTS

Hereinafter, various embodiments will be described with reference to the drawings as needed. Components common to a plurality of drawings are given the same reference numerals throughout the plurality of drawings. The embodiments described below do not limit the disclosure according to the scope of the claims. Components described in the following embodiments are not necessarily essential to the solving means of the disclosure.

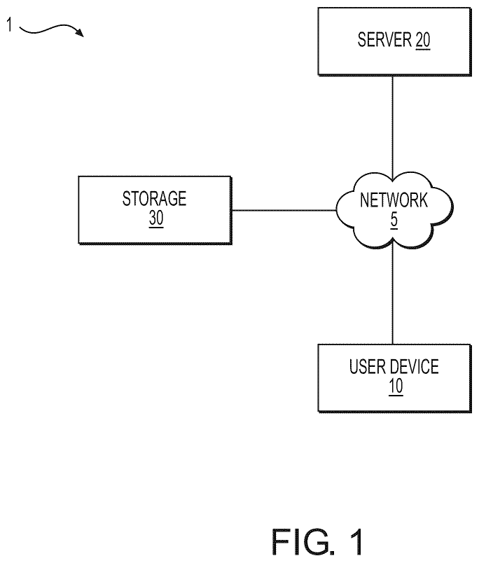

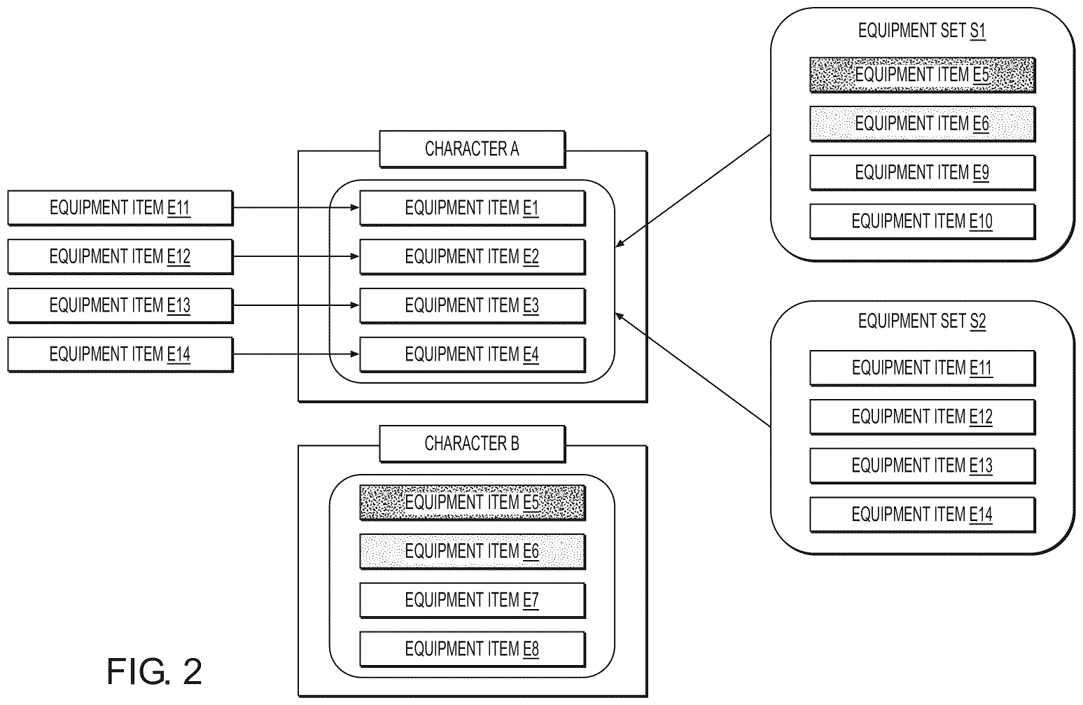

First, an overview of a game system 1 according to an embodiment will be described with reference to FIGS. 1 and 2. The game system 1 is an example of a game system to which this disclosure is applied.

### 1. Overview of Game System 1

FIG. 1 is a block diagram showing the game system 1. As shown in FIG. 1, the game system 1 includes a user device 10 and a server 20. The game system 1 may also include a storage 30. To simplify the illustration, one user device 10 is shown in FIG. 1, but the game system 1 may include a plurality of user devices. The user device 10, the server 20, and the storage 30 are connected to each other so that they can communicate with each other via a network 5. The network 5 may be a single network, or may be configured by connecting a plurality of networks. The network 5 may be, for example, the Internet, a mobile communication network, or a combination of these. As the network 5, any network that enables communication between electronic devices may be applied.

The user device 10 executes a command set included in a computer program to realize various functions related to a game. The server 20 can provide various services related to the game to the user device 10. The user device 10 and the server 20 can cooperate with each other as needed to realize various functions of the game.

The game system 1 shown in FIG. 1 is an example of a system to which this disclosure can be applied. Not all of the components of the game system 1 shown in FIG. 1 are necessarily required to realize this disclosure. For example, the user device 10 may provide a game in a stand-alone manner. In this case, the server 20 is not an essential component of the game system 1.

### 2. Overview of Game Provided by Game System 1

The game system 1 can provide games of various genres. In the games provided by game system 1, the user can progress through the game by controlling a plurality of characters. In this specification, characters controlled by the user may be referred to as the “user characters” of the user. The games provided by the game system 1 can include a plurality of game parts. The game parts of the games provided by the game system 1 may include (i) a battle game part in which a user party constituted by a plurality of user characters fights against an enemy character(s), (ii) a search part in which the user character is controlled to search within a game field, and (iii) game parts other than these. In the games provided by the game system 1, when an enemy character is encountered during play in the search part, a game mode may be switched from the search part to the battle game part.

In the games provided by the game system 1, the user characters can be equipped with a plurality of equipment items. The equipment items can include, for example, weapons, armor, magic, skills, abilities, tool items, special effect items, or items other than these that can be equipped to the user characters. An upper limit may be set for the equipment items that can be equipped to the user characters. In one aspect, a user character(s) can be equipped with one equipment item for each type of equipment. For example, a user character can be equipped with four equipment items in total, one each of a weapon, armor, magic, and tool. In another aspect, a user character can be equipped with a plurality of equipment items of one type. For example, a user character can be equipped with two or more equipment items corresponding to weapons. When a user character is equipped with two or more weapons, for example, one weapon can be equipped in the right hand and another weapon in the left hand. Also, a user character may be able to be equipped with a plurality of tools. For example, a user character may be able to be equipped with a plurality of recovery tools (called medicinal herbs, restoratives, or the like).

### 3. Equipment and Changes of Equipment Items

With reference to FIG. 2, the equipment items equipped to the user character(s) and the changes of the equipment items will be further described. In the following description, to simplify the explanation, it is assumed that a user plays a game using two characters, characters A and B. In the games provided by the game system 1, the user can also use three or more characters. The following description of a process for equipping two characters with equipment items and a process for changing the equipment items of the two characters can also be applied to equipping and changing equipment items when three or more characters are used.

FIG. 2 shows equipment items equipped to the user characters A and B. FIG. 2 also schematically shows a process for changing the equipment items equipped to the user character A.

In the example shown in FIG. 2, both the characters A and B are equipped with four equipment items. Specifically, the character A is equipped with equipment items E1, E2, E3, and E4, and the character B is equipped with equipment items E5, E6, E7, and E8. In the following explanation, it is assumed that when changing equipment items, the character A is equipped with equipment items E1 to E4, and the character B is equipped with the equipment items E5 to E8. That is, the equipment items E1-E4 are equipment for the character A at the time an equipment change request is accepted, and the equipment items E5-E8 are equipment for the character B at the time an equipment change request is accepted. The equipment for the character A at the time an equipment change request is accepted may be referred to as “pre-change equipment” for the character A or “current equipment” for the character A. Similarly, equipment for the character B at the time an equipment change request is accepted may be referred to as “pre-change equipment” for the character B or “current equipment” for the character B.

The equipment items equipped to the character A or B may be available to the user from the start of the game. At the start of the game, only part of the plurality of equipment items provided by the game may be available, and available equipment items may be added as the game progresses. For example, available equipment items may be added when an experience value or level of the user reaches a predetermined value or above, when a specific enemy character is defeated, when a specific quest is cleared, or when an item addition condition other than these is satisfied. When the user discovers an equipment item located within a game space by exploring the game space using a user character, the user may equip the discovered equipment item to the user character. The user may purchase an equipment item. The user may obtain an equipment item gifted by a friend. The user may obtain an equipment item by using a gacha (loot box). The method or route of acquiring an equipment item is not limited to those explicitly described in this specification. The user may acquire an equipment item by a method not explicitly described in this specification.

In the game provided by the game system 1, one equipment item may be equipped only to one user character. In this case, in regulations of the game provided by the game system 1, while a certain equipment item is equipped to one user character, other user characters are not allowed to be equipped with the equipment item. For example, in the example shown in FIG. 2, the equipment item E1 is equipped to the character A; therefore, the character B cannot be equipped with the equipment item E1 unless the character A releases equipment of the equipment item E1.

In the game provided by the game system 1, the user may have fewer equipment items than the number of user characters operated by the user. In this case, the equipment items cannot be equipped to all of the user characters. For example, when the user plays the game using three characters, characters A, B, and C, if the user has only two equipment items E1, only two characters among the characters A, B, and C are allowed to be equipped with the equipment items E1.

When changing the equipment items equipped to a user character, an equipment set, which is a combination of a plurality of equipment items, can be used. In FIG. 2, equipment sets S1 and S2 are shown as examples of equipment sets. The equipment set S1 is a combination of four equipment items, the equipment items E5, E6, E9, and E10. The equipment set S2 is a combination of four equipment items, the equipment items E11, E12, E13, and E14. Each equipment set can include a number of equipment items equal to the number of equipment items that can be equipped to the user character. In the illustrated examples, it is assumed that each user character can be equipped with four equipment items; therefore, each equipment set also includes four equipment items.

The current equipment of the user character A can be changed to another equipment item(s). For example, as shown in the figure, the character A may be newly equipped with the equipment item E11 instead of the equipment item E1 currently equipped. When the user character A is newly equipped with the equipment item E11, equipment of the equipment item E1 is released. Similarly, the character A can be newly equipped with the equipment item E12 instead of the equipment item E2, newly equipped with the equipment item E13 instead of the equipment item E3, and newly equipped with the equipment item E14 instead of the equipment item E4.

When changing the current equipment for the character A to another equipment item(s), the new equipment item(s) may be specified individually, or by specifying an equipment set to be applied, the equipment items that constitute that equipment set may be collectively specified as new equipment items to be equipped. In the examples shown in FIG. 2, if the user is made to individually specify the equipment items E11, E12, E13, and E14 that are new equipment for the character A, an operational burden on the user is large. In particular, when the number of equipment items increases, it becomes difficult to find a desired equipment item from among all the equipment items possessed. In order to reduce such a burden, the user can apply the equipment set S2 to the character A. The equipment set S2 is a combination of the equipment items E11, E12, E13, and E14; therefore, by applying the equipment set S2 as new equipment for the character A, the equipment items E11, E12, E13, and E14 can be collectively specified as new equipment for the character A.

When a plurality of equipment sets are available, the user can select a desired equipment set from the plurality of equipment sets. In the examples of FIG. 2, two types of equipment sets, the equipment sets S1 and S2, are shown. The number of equipment sets available to the user is not limited to two, and may be three or more. As will be described in detail later, the number of equipment sets available to the user may be changed according to the progress of the game.

FIG. 2 shows the equipment set S1 in addition to the equipment set S2 already described. The equipment set S1 is a combination of the equipment items E5, E6, E9, and E10. The equipment set S1 includes the equipment items E5 and E6 currently equipped to the character B, and is different from the equipment set S2, which does not include the equipment items currently equipped to the character B. When the equipment items E5 and E6 can only be equipped to one character, when attempting to apply the equipment set S1 to the character A, a conflict occurs between the characters A and B regarding the equipment items E5 and E6 that overlap with each other. For example, if priority is given to equipping the character A with the equipment items included in the equipment set S1, the equipment items E5 and E6 will be removed from the character B. If the user is not aware that the equipment items E5 and E6 included in the equipment set S1 overlap with the current equipment for the character B when deciding to apply the equipment set S1 to the character A, applying the equipment set S1 to character A will result in the equipment items E5 and E6 being removed from the character B against the user's intention. Therefore, even if the user gives an instruction to apply the equipment set S1 to the character A, if the equipment items included in the equipment set S1 are simply adopted collectively as new equipment items for the character A, there is a possibility that the equipment for the character B may be changed against the user's intention.

On the other hand, if the application of the equipment set S1 to the character A is demanded but the equipping of the equipment items E5 and E6 to the character B is maintained, the character A will be able to be equipped with only some of the plurality of equipment items in the equipment set S1. In this case, there is a possibility that the equipment for the character A after applying the equipment set S1 may not reflect the user's intention.

Conventionally, when an equipment set is applied to a user character, even if there is a conflict between a plurality of user characters regarding equipment items included in the equipment set, the conflicting relationship is automatically resolved by a conflict resolution process set in the game. For example, when an equipment set is applied to a certain user character, even if another user character is equipped with an equipment item included in the equipment set, a process is automatically performed to release the equipment of the conflicting equipment item from the other user character. In one aspect, when a conflict occurs between a plurality of user characters over equipment items included in an equipment set, a new user interface for equipment change is used to make the user aware of the conflict and to receive commands from the user to resolve the conflicting relationship. In one aspect, it is possible to determine which user character is to be equipped with equipment items in a conflicting relationship based on a user instruction received through the user interface for equipment change, so that it is possible to resolve the equipment items in a conflicting relationship as intended by the user while maintaining the convenience of changing the equipment of the user character collectively using an equipment set. A specific example of this user interface for equipment change will be described later together with the functions of the game system 1.

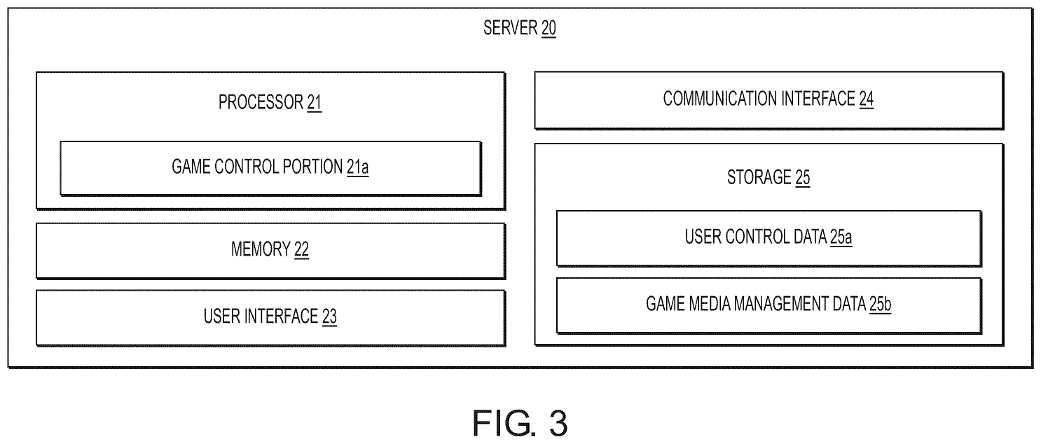

Next, the game system 1 will be described in more detail with reference to FIGS. 3 to 8.

### 4. Server 20

First, the server 20 provided in the game system 1 will be explained with reference to FIG. 3.

### 4-1. Configuration of Server 20

The server 20 includes a processor 21, a memory 22, a user interface 23, a communication interface 24, and a storage 25.

The processor 21 is an arithmetic device that loads an operating system and various other programs from the storage 25 or other storage into the memory 22 and executes commands included in the loaded programs. The processor 21 is, for example, a CPU, an MPU, a DSP, a GPU, various other arithmetic devices, or a combination of these. The processor 21 may be realized by an integrated circuit such as an ASIC, a PLD, an FPGA, or an MCU.

The memory 22 is used to store commands executed by the processor 21 and various other data. The memory 22 is a main memory that can be accessed at high speed by the processor 21. The memory 22 is configured by, for example, a RAM such as a DRAM or an SRAM.

The user interface 23 includes an input interface that accepts input from a user or an operator, and an output interface that outputs various information under the control of the processor 21. The input interface is a keyboard, a pointing device such as a mouse, a touch panel, or any information input device other than these that is capable of inputting user input.

The output interface is, for example, a liquid crystal display, an organic EL(Electro-Luminescence) display, a display panel, or any information output device other than these that is capable of outputting the calculation results of a processor 21.

The communication interface 24 is implemented as hardware, firmware, or communication software such as a TCP/IP driver or a PPP driver, or a combination of these. The server 20 can transmit and receive data to and from other information devices including the user device 10 via the communication interface 24.

The storage 25 is an external storage device accessed by the processor 21. The storage 25 is, for example, a magnetic disk, an optical disk, a semiconductor memory, or various storage devices other than these that are capable of storing data.

### 4-2 Data Held in Server Device

The storage 25 stores user management data 25a, game media management data 25b, and data other than these that are required for providing the game.

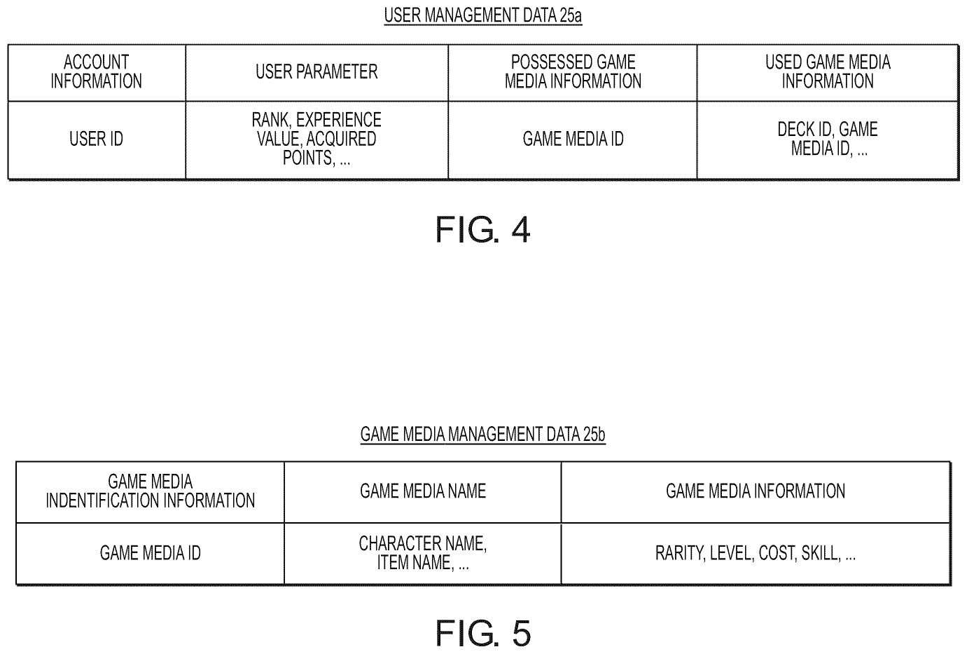

The user management data 25a will be described with reference to FIG. 4. The user management data 25a is a data set in which various data related to a user who plays a game provided by the game system 1 is structurally stored. The user management data 25a may include user account information, user parameters which are various parameters set for the user, possessed game media information related to game media possessed by the user, used game media information related to the used game media used by the user in the game, and various data other than these that are related to the user.

The account information is, for example, a user ID for identifying a user. The account information may include a user name. In the game system 1, a user is uniquely identified by the user ID. The user name shows the name of the user used in the game.

The user parameters of a user may include the user's rank, experience points, acquired points, and other user parameters associated with the user that change as the user plays a game. The user's rank is a parameter that shows the user's skill regarding the game. The rank may increase as the user plays the game.

Game media information possessed by a user is information regarding game media possessed by the user in a game. Game media are electronic data used in a game. The game media may include, for example, characters, cards, items (including equipment items), points, in-service currency (or in-game currency), tokens (for example, Non-Fungible Tokens (NFTs)), tickets, avatars, parameters, and electronic data used in the game other than these. The game media may be acquired, possessed, used, managed, exchanged, combined, reinforced, sold, discarded, or gifted by the user within the game. The game media may also be used in a manner other than the above. Possessed game media information may include a game medium ID that identifies a game medium possessed by the user within the game. When a game medium is acquired by the user, the game medium ID that identifies the game medium is stored as possessed game medium information in association with the user ID of the user. Hereinafter, unless otherwise specified, a game medium “possessed” by a user refers to a game medium associated with the user ID of the user. Furthermore, “granting” a game medium to a user means associating the game medium with the user ID of the user as a game medium “possessed” by the user. Furthermore, “discarding” a game medium possessed by a user means cancelling the association between the user ID of the user and the game medium. Additionally, “consuming” a game medium possessed by a user means generating an effect in the game according to the cancellation of the association between the user ID and the possessed game medium. Furthermore, “selling” a game medium possessed by a user means cancelling the association between the user ID and the game medium of the user and associating the user ID with another game medium (for example, virtual currency, items, or the like) as a possessed game medium. Furthermore, “transferring” a game medium possessed by a user A to a user B means cancelling the association between the game medium and user ID of the user A, and associating the game medium with the user ID of the user B. Furthermore, “creating” a game medium means defining or determining at least part of the information related to the game medium.

The used game media information is information showing the game media used by the user in a game part (for example, the battle game part). The game media used by the user in the battle game part are selected from among the possessed game media. The character used by the user in the battle game part (that is, the user character) may be selected according to a selection operation by the user, or selected automatically, from among the used game media. When a plurality of user characters are selected to execute the battle game part, a party may be constituted by the selected plurality of user characters. In this case, the used game medium information may include a party ID for identifying the party constituted by the user characters selected as the used game media.

The user management data 25a may include friend information. The friend information for a certain user shows the user IDs of users who are friends with the certain user. For example, if a user A is friends with users B and C, the friend information for the user A includes the user IDs of the users B and C. Users who are friends can play a game together.

Part of the data stored as the user management data 25a is updated as the game progresses. For example, the rank of a user increases as the user plays the game. Part of the data stored as the user management data 25a is not updated as the game progresses. For example, the user ID remains unchanged even as the game progresses.

The game media management data 25b will be described with reference to FIG. 5. The game media management data 25b is a data set in which various data related to game media, such as characters used by a user in a game provided by the game system 1, are structurally stored. The game media management data 25b includes data related to user characters. The game media management data 25b includes game media identification information, game media names (character names or the like), and game media information for various user characters.

The game media identification information of a user character is, for example, a character ID that identifies the character. The game media identification information may include character names that show the name of each character.

The game media information of a user character includes various information showing the characteristics of the user character. The character information includes, for example, rarity, cost, life, attack power, defense power, and game function information. Rarity is information showing the rarity level (scarcity value) of a user character. That is, the rarity associated with a certain user character shows the difficulty of acquiring the user character.

The cost is a parameter used when determining a deck to be used in the battle game part. For example, a party (sometimes referred to as a “deck”) is set with an upper limit value on the total cost of user characters that can be included in the party. The user can select user characters to be included in the party so that the total cost does not exceed the upper limit value.

Life is a parameter used to determine whether the user wins or loses in the battle game part. In the battle game part, the user's character is attacked by an enemy character, causing the user's life to reduce. Life may be restored to an upper limit value or below by using a recovery item(s). When the lives of all characters included in the user's deck reach zero, it may be determined that the user has been defeated in the battle game part.

The attack power of a user character is a parameter that contributes to the amount of damage inflicted on an enemy character by an attack from the user character. The larger the value of the attack power, the greater the amount of damage inflicted on an enemy character. The defense power of a user character is a parameter that contributes to the amount of damage the user character receives from an attack by an enemy character. The larger the value of the defense power, the smaller the amount of damage the user character receives from an attack by an enemy character.

At least part of the user management data 25a and the game media management data 25b is referenced by the user device 10 as needed. At least part of the user management data 25a and the game media management data 25b may be stored in the user device 10 as needed.

### 4-3 Function of Server 20

The processor 21 of the server 20 functions as a game controller 21a by executing a command set included in a program stored in the storage 25 and other command sets as needed. The game controller 21a processes requests and notifications from the user device 10 based on a predetermined game logic, and also provides the user device 10 with various game data for executing the game, thereby controlling the progress of the game.

### 5. User Device 10

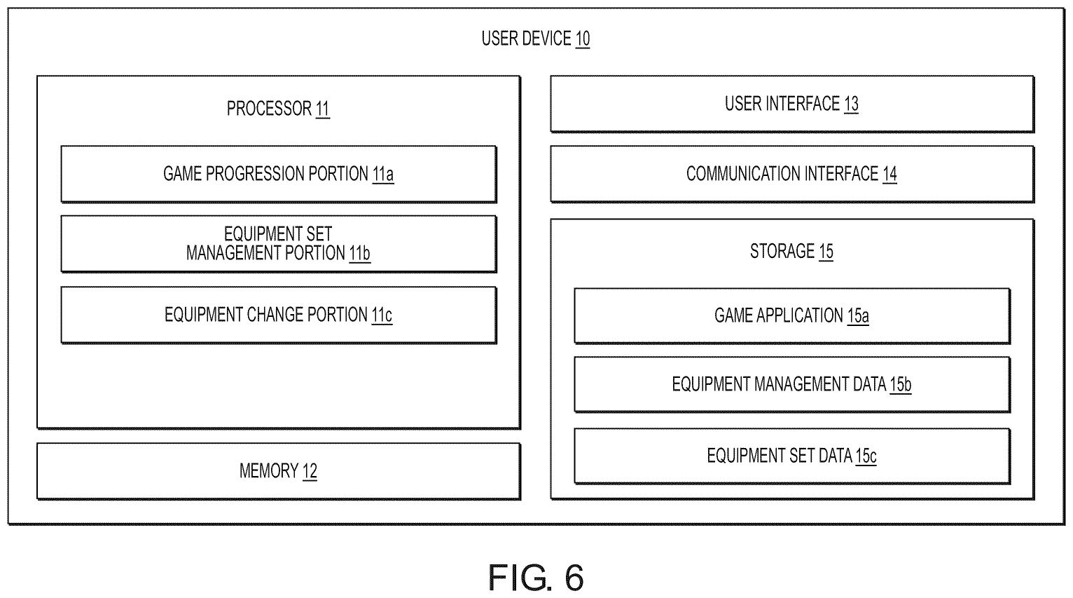

Next, with further reference to FIG. 6, the user device 10 included in the game system 1 will be explained.

### 5-1 Configuration of User Device 10

The user device 10 is a smartphone, a personal computer (PC), a mobile phone, a tablet terminal, an e-book reader, a wearable computer, a game console, a head-mounted display, or various information processing devices other than these. It is assumed that the user device 10 is used by a game player (user). A first user inputs information into the user device 10 and can play the game through video and audio output from the user device 10.

The user device 10 includes the processor 11, a memory 12, a user interface 13, a communication interface 14, and a storage 15. The explanation of the processor 21, the memory 22, the user interface 23, the communication interface 24, and the storage 25 of the server 20 also applies to the processor 11, the memory 12, the user interface 13, the communication interface 14, and the storage 15 of the user device 10.

### 5-2 Data Held by User Device 10

The storage 15 stores a game application 15a for providing various game functions, equipment management data 15b, equipment set data 15c, and various data other than these.

Commands included in the game application 15a may be executed by the processor 11. Details of functions realized by executing the game application 15a will be described later. The game application 15a may be downloaded to the user device 10, for example, from an undepicted application distribution platform. The user device 10 can obtain data required for progressing through the game part from the server 20 as needed, and store the obtained data in the storage 15.

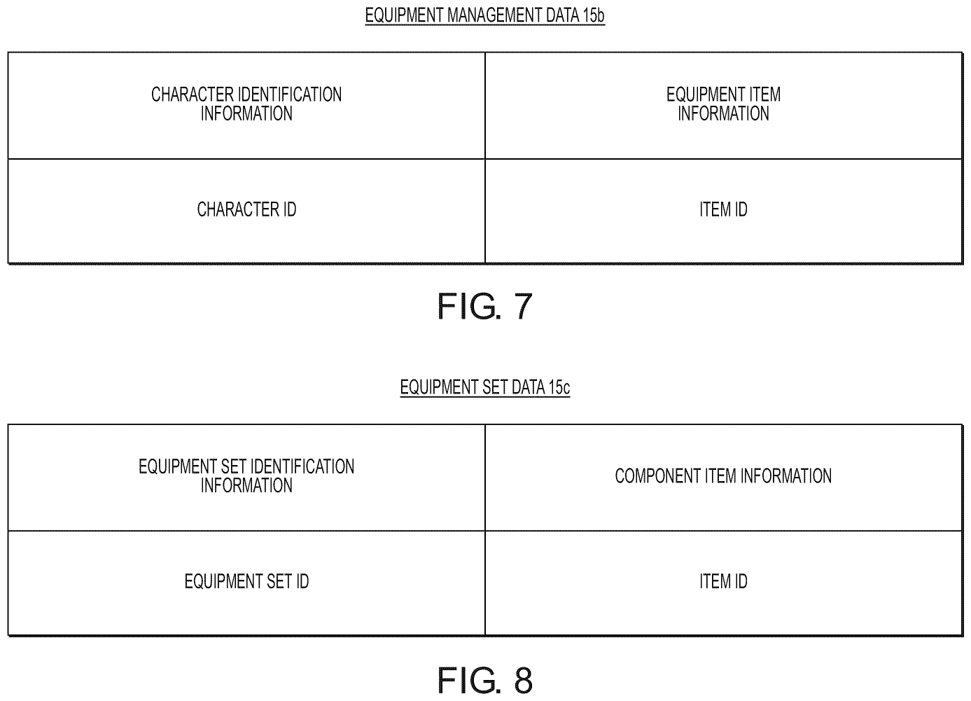

The equipment management data 15b will be explained with reference to FIG. 7. The equipment management data 15b is a data set in which data related to equipment items equipped by each user character are structurally stored. In one aspect, the equipment management data 15b includes character identification information for identifying the user character(s), and equipment item information for identifying the equipment items equipped to each user character.

The character identification information is data for identifying a user character(s) used by a user to play a game, and may be, for example, a character ID that identifies a user character.

The character identification information may include a character name.

The equipment item information is data for identifying an equipment item equipped to a user character, for example, an item ID that identifies the equipment item. By storing an item ID in association with the character ID, it is possible to manage whether a user character identified by the character ID is equipped with the equipment item. A plurality of item IDs can be stored in association with one character ID. In the example explained with reference to FIG. 2, one user character can be equipped with four equipment items. In this case, up to four item IDs can be stored in association with one character ID. In the example shown in FIG. 2, the character A is equipped with equipment items E1 to E4; therefore, in the equipment management data 15b, four item IDs that identify each of the equipment items E1 to E4 are stored in association with the character ID for the character A.

The equipment set data 15c will be explained with reference to FIG. 8. The equipment set data 15c is a data set in which data related to equipment sets, which are combinations of a plurality of equipment items, are structurally stored. In one aspect, the equipment set data 15c includes equipment set identification information that identifies the equipment sets, and component item information that identifies each of the plurality of equipment items that constitute each equipment set.

The equipment set identification information is data for identifying an equipment set available to the user, for example, an equipment set ID that identifies the equipment set. As the equipment set identification information, a number of equipment set IDs corresponding to an upper limit number of equipment sets available to the user are stored. The upper limit number of equipment sets available to the user may be updated according to the progress of the game and changes to the user settings. For example, the upper limit number of equipment sets available to the user can be increased by (i) the user's experience value or level reaching a predetermined value or more, (ii) defeating a specific enemy character, (iii) clearing a specific quest, (iv) exceeding a predetermined game play time, or (v) satisfying an equipment set addition condition other than these. If a large number of equipment sets were available from the start of the game, a large amount of storage capacity would need to be reserved for storing the equipment set data 15c, which could lead to a waste of storage resources. Therefore, by setting the number of equipment sets available at the start of the game at a low number and then increasing the upper limit of equipment sets as the game progresses, it is possible to suppress waste of storage resources while allowing highly engaged users (for example, users who play the game for a long time or complete many quests in the game) to use more equipment sets.

At least part of the equipment management data 15b and the equipment set data 15c may be stored in the server 20, as needed.

### 5-3 Functions of User Device 10

The processor 11 of the user device 10 functions as a game progression portion 11a, an equipment set management portion 11b, and an equipment change portion 11c by executing a command set included in the game application 15a and, as needed, command sets other than these.

### 5-3-1 Game Progression Portion 11a

The game progression portion 11a causes the game to progress according to the command set included in the game application 15a, and, as needed, based on input from the first user via the user interface 13 (for example, physical buttons or a GUI displayed on a touch panel of a game console) of the user device 10. The game progression portion 11a can also cause the game to progress in cooperation with the server 20. Operational inputs from the user include, for example, (i) an input for specifying movement of the user character within the game field, (ii) an input for changing a game setting, (iii) an input for selecting an equipment item, and (v) various inputs other than these related to the progress of the game.

The game progression portion 11a can generate requests related to the progress of the game based on a command set included in the game application 15a and input from the user, and transmit the generated requests to the server 20. The game progression portion 11a can also receive various game data related to the progress of the game from the server 20, and cause the game to progress based on the game data. The game progression portion 11a can display images according to the progress of the game on the user interface 13 (for example, a display).

When a conflict occurs between a plurality of user characters over an equipment item(s) included in an equipment set, a user interface for equipment change that causes the user to be aware of the conflicting relationship and receives instructions from the user to resolve the conflicting relationship is realized by using the input interface and the output interface included in the user interface 13.

The game progression portion 11a may obtain data required for the progress of the game from among the various data stored in the storage 25 of the server 20, and store the obtained data in the storage 15. When required for game processing, the game progression portion 11a can read out appropriate data from the storage 15, and perform calculations using the read data.

### 5-3-2 Equipment Set Management Portion 11b

The equipment set management portion 11b can perform processing for changing equipment items included in an equipment set, adding equipment sets, and processing other than these for managing equipment sets based on input from the user.

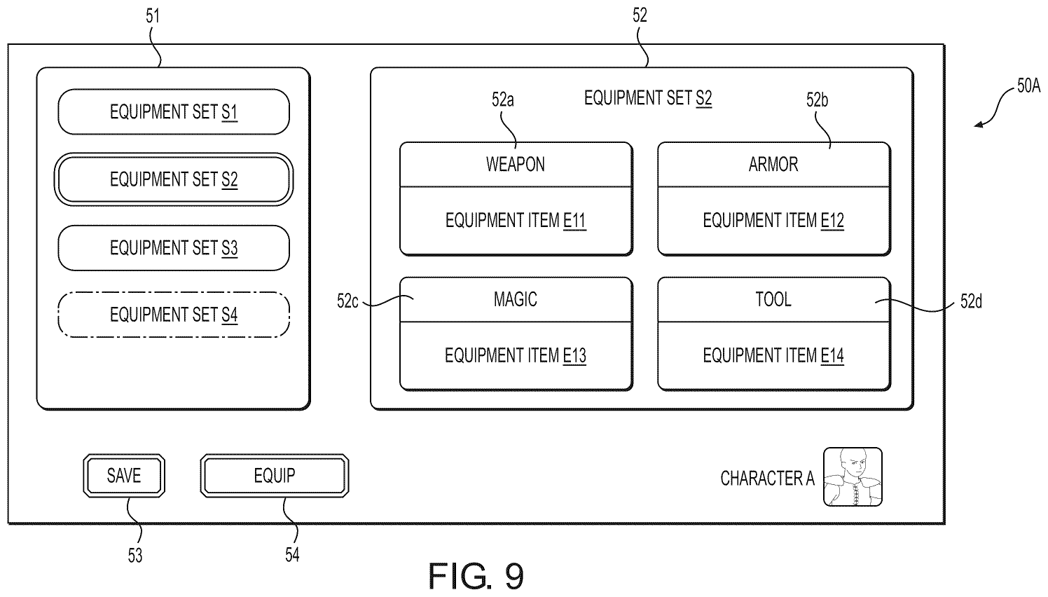

FIG. 9 shows an example of an equipment set management screen displayed on a display of the user device 10 for managing equipment sets. An equipment set management screen 50A shown in FIG. 9 may be displayed on the user device 10 according to a user operation while a game is being played. FIG. 9 shows an equipment set management screen 50A for managing the equipment set for the character A, from among the characters A and B used by the user to play the game. The equipment set management screen for managing the equipment set for the character B is configured in the same manner as the equipment set management screen 50A for the character A.

The equipment set management screen 50A shown in FIG. 9 includes an equipment set list 51 and a configuration item display area 52. The equipment set list 51 displays a list of equipment sets applicable to the character A. The configuration item display area 52 displays information regarding the equipment items that constitute the equipment set selected from the equipment set list 51.

In the example shown in FIG. 9, the equipment sets S1 and S2 and an equipment set S3 are included as equipment sets available to the user in the equipment set list 51. An equipment set S4 is currently unavailable, but will become available when an equipment set addition condition is satisfied. For example, the equipment set S4 may become available when the user reaches a predetermined level. When the equipment set S4 becomes available, the user can select a plurality of equipment items different from the equipment items included in the equipment sets S1 to S3 and configure the equipment set S4 by combining the selected plurality of equipment items. The equipment set S4 may be displayed in gray on the equipment set management screen 50A until it becomes available.

The configuration item display area 52 displays information regarding the equipment items that constitute the equipment set selected in the equipment set list 51. The information regarding the equipment items displayed in the configuration item display area 52 is an example of “set item information” recited in the scope of the claims. The configuration item display area 52 includes (i) a first display area 52a for displaying an equipment item corresponding to a weapon, (ii) a second display area 52b that displays an equipment item corresponding to armor, (iii) a third display area 52c that displays an equipment item corresponding to magic, and (iv) a fourth display area 52d that displays an equipment item corresponding to a tool. In the example shown in FIG. 9, the equipment set S2 is selected from among the plurality of equipment sets included in the equipment set list 51; therefore, the equipment item E11, which corresponds to a weapon, from among the plurality of equipment items included in the equipment set S2 is displayed in the first display area 52a. Similarly, the second display area 52b displays an equipment item E12 corresponding to armor from among the plurality of equipment items included in the equipment set S2, the third display area 52c displays the equipment item E13 corresponding to magic, and the fourth display area 52d displays the equipment item E14 corresponding to a tool.

The user can update the equipment items constituting the equipment set via the equipment set management screen 50A. Hereinafter, an equipment item update process via the equipment set management screen 50A will be explained. In addition to updating the equipment items, in the equipment set management screen 50A, the equipment items that constitute an equipment set can be collectively equipped to the user character. The process for collectively equipping the user character with the equipment items included in the equipment set will be explained in relation to the functions of the equipment change portion 11c after the explanation of the equipment item update process.

The user device 10 can accept various command inputs from the user on the equipment set management screen 50A via the user interface 13. For example, when any one of the first display area 52a, the second display area 52b, the third display area 52c, and the fourth display area 52d is selected on the equipment set management screen 50A displayed on the display, an equipment change request for changing the equipment item set in the selected display area may be generated. When the equipment set management portion 11b receives an equipment change request, it generates an equipment item change window and displays the generated equipment item window on the display of the user device 10. For example, because the first display area 52a displays the equipment item corresponding to a weapon, when the first display area 52a is selected, an equipment item change window for changing the equipment item corresponding to a weapon that constitutes the equipment set S2 is displayed on the display of the user device 10.

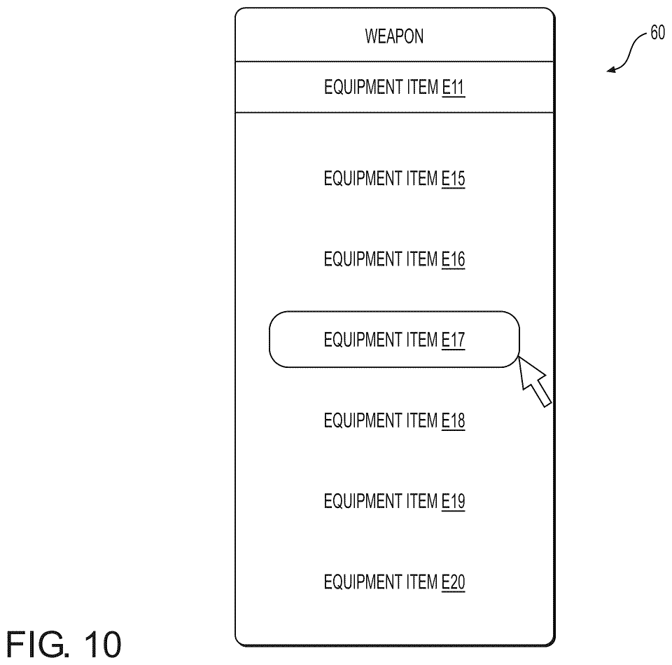

An example of an equipment item change window is shown in FIG. 10. When the first display area 52a is selected, an equipment item change window 60 is displayed as shown in FIG. 10. The equipment item E11 currently included in the equipment set S2 is displayed at the top of the equipment item change window 60. A list of the equipment items that correspond to weapons held by the user are displayed in the equipment item change window 60. In the example of FIG. 10, equipment items E15 to E20 are displayed as equipment items corresponding to weapons held by the user. By selecting one of the equipment items displayed in the equipment item change window 60, the user can set the selected equipment item as the equipment item corresponding to the weapon that constitutes the equipment set S2. For example, as shown in FIG. 10, when the equipment item E17 is selected in the equipment item change window 60, the weapon constituting the equipment set S2 is updated from the equipment item E11 to the equipment item E17. The equipment items corresponding to armor, magic, and tools can also be updated in the same manner as the equipment items corresponding to weapons, by selecting the second display area 52b, the third display area 52c, or the fourth display area 52d to open the equipment item change window and selecting a new equipment item in the equipment item change window. The equipment item change window 60 may be displayed as an overlay on the equipment set management screen 50A.

Equipment items equipped to other user characters may be displayed in the equipment item change window. The equipment item change window 60 for changing the equipment item corresponding to the weapon for the character A shown in FIG. 10 may display the equipment item E5 corresponding to the weapon equipped to the character B. Additionally, in association with each equipment item displayed in the equipment item change window 60, an image showing the character equipped with each equipment item may be displayed. For example, when the equipment item E15 is equipped to a character other than the character A, a character image showing the other character may be displayed in association with the equipment item E15 (for example, directly next to the equipment item E15). An equipment item that is not equipped to any character is not displayed in association with any character image. In the equipment item change window 60, by displaying an image showing a character equipped with an equipment item in association with the equipment item, the user can set the equipment items to be included in the equipment set so as not to overlap with equipment items already equipped to other characters.

When a save button 53 is selected after the equipment item E17 is selected in the equipment item change window 60, the process for updating the weapon included in the equipment set S2 from the equipment item E11 to the equipment item E17 is completed. Specifically, when the save button 53 is selected, an equipment update request for the equipment set S2 is generated, and the equipment set management portion 11b updates the item ID stored in association with the equipment set S2 in the equipment set data 15c according to this update request. In the updated equipment set data 15c, an item ID that identifies the equipment item E17 newly set as a weapon for the equipment set S2 is stored in association with the equipment set ID that identifies the equipment set S2. The item ID corresponding to the equipment item E11 excluded from the equipment set S2 is deleted from the equipment set data 15c.

FIGS. 9 and 10 explain a process for updating equipment items constituting the equipment set S2. The process for updating equipment items constituting equipment sets other than the equipment set S2 is performed in the same manner as the update process for the equipment set S2. Furthermore, regarding an equipment set in which no equipment items are set (for example, an equipment set that becomes available immediately after the item addition condition is satisfied), new equipment items corresponding to a weapon, armor, magic, and a tool can be set for each of them.

### 5-3-3 Equipment Change Portion 11c

When one of the plurality equipment sets displayed in the equipment set list 51 is selected at the user device 10 and further, an instruction is given to apply that equipment set to the user character, the equipment change portion 11c can collectively equip the user character with the plurality of equipment items included in that equipment set. The process for the equipment change portion 11c includes a process for providing a user interface for equipment change. When a conflict occurs between a plurality of user characters regarding an equipment item(s) included in an equipment set, the user can be made aware of the conflicting relationship by the user interface provided by the equipment change portion 11c. At least part of the process for providing the user interface for equipment change may be executed by a portion other than the equipment change portion 11c. Hereinafter, a specific process executed by the equipment change portion 11c will be explained.

When one of the equipment sets displayed in the equipment set list 51 is selected at the user device 10, the equipment change portion 11c determines whether each of the equipment items included in the equipment set overlaps with any of the equipment items equipped to another character(s). The selection of the equipment set is accepted on the equipment set management screen 50A, for example. In the example shown in FIG. 9, the equipment set S2 is selected in the equipment set list 51 of the equipment set management screen 50A for the character A. When the selection of the equipment set S2 for the character A is accepted on the equipment set management screen 50A, the equipment change portion 11c determines whether the equipment items E11 to E14 included in the equipment set S2 overlap with the equipment items E5 to E8 equipped to a character other than the character A (that is, character B) used by the user in the game. The equipment set S2 does not include any of the equipment items E5 to E8 equipped to the character B. As a result, when the equipment set S2 is selected, it is determined that the equipment items E11 to E14 included in the equipment set S2 do not overlap with the equipment items E5 to E8 equipped to the character B. Whether an equipment item included in an equipment set overlaps with an equipment item equipped to another character can be determined at various timings. For example, when the equipment set management screen 50A is generated, for each equipment set included in the equipment set list 51, it may be determined whether the equipment items included in each equipment set overlap with equipment items currently equipped to another character(s). Additionally, when the equipment items constituting an equipment set are updated, it may be determined whether the equipment items newly included in the equipment set overlap with equipment items equipped to another character(s).

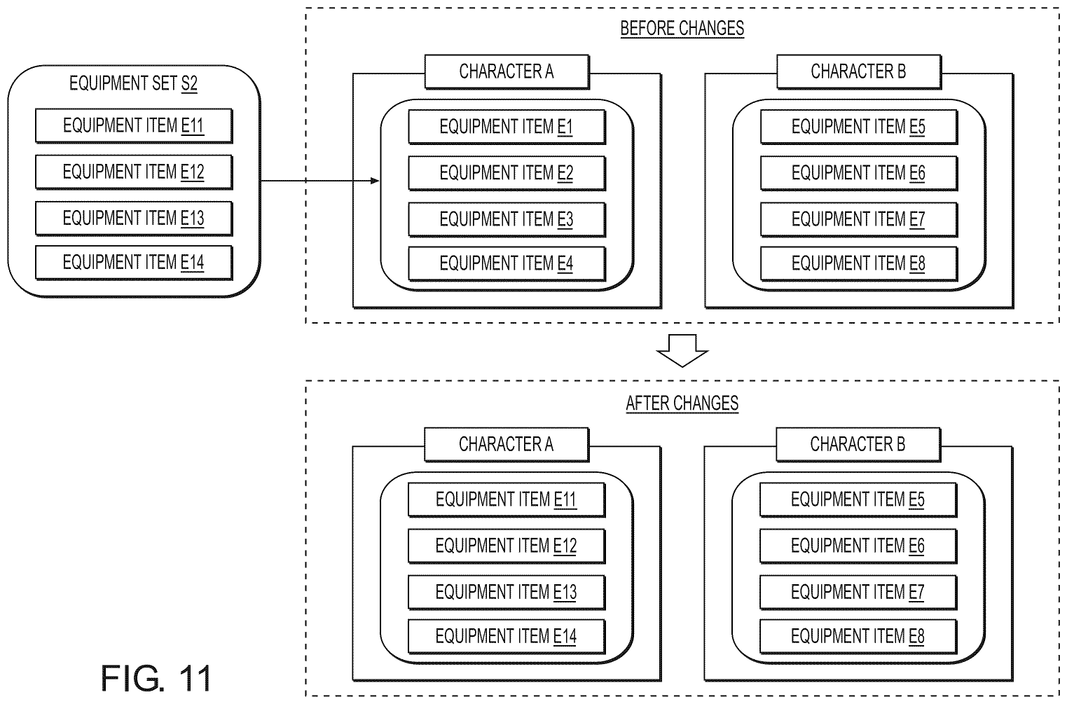

When the equipment change portion 11c receives the selection of an “equip” button 54 while the equipment set S2 is being selected, the equipment change portion 11c replaces the items currently equipped to the user A (that is, the equipment items E1 to E4) with the equipment items E11 to E14 included in the equipment set S2, respectively, as shown in FIG. 11. Specifically, when the “equip” button 54 is selected, the equipment change portion 11c accepts an equipment change request for changing the equipment items for the character A, and updates the item IDs stored in association with the character A in the equipment management data 15b according to the accepted equipment change request. In the updated equipment management data 15b, four item IDs that respectively identify the equipment items E11 to E14 newly equipped to the character A are stored in association with the character ID that identifies the character A. The item IDs corresponding to the equipment items E1 to E4 equipped to the character A before the equipment change request has been accepted are deleted from the equipment management data 15b. Thus, if it is determined that the equipment items included in the equipment set selected for the character A do not overlap with the equipment items for the character B, each of the equipment items included in the equipment set is set as new equipment for the character A.

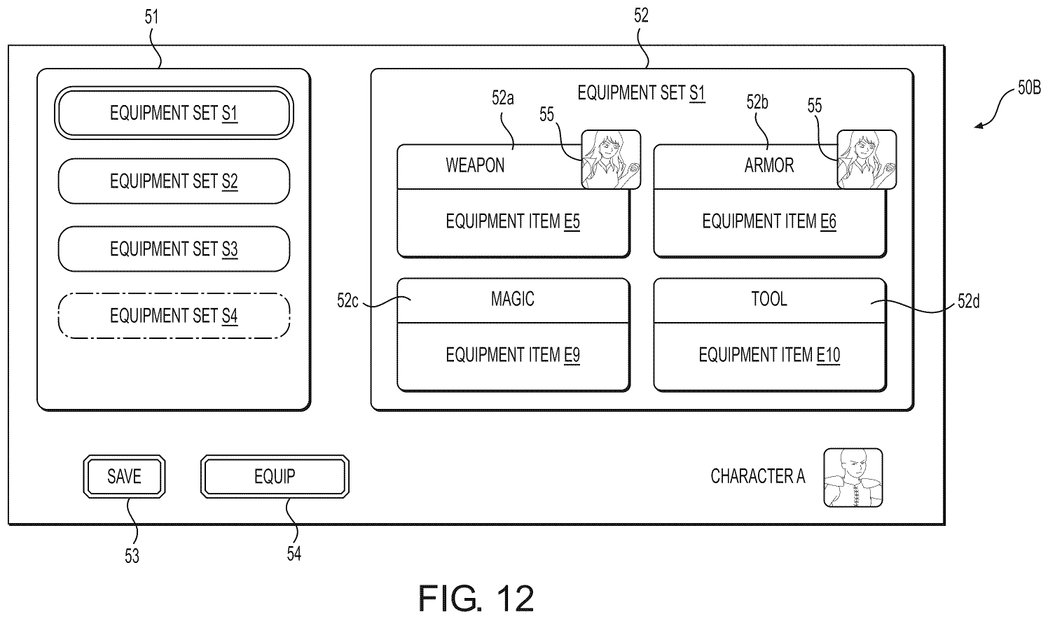

Next, a process for changing equipment items when the equipment set S1 is selected will be explained with reference to FIGS. 12 to 14. FIG. 12 shows an equipment set management screen 50B that is displayed on the user device 10 when the equipment set S1 is selected. As shown in FIG. 12, when the equipment set S1 is selected from the equipment set list 51, the equipment items E5, E6, E9, and E10 included in the equipment set S1 are displayed in the configuration item display area 52. Additionally, in response to receiving the selection of the equipment set S1, the equipment change portion 11c determines whether the equipment items E5, E6, E9, and E10 included in the equipment set S1 overlap with the equipment items E5 to E8 equipped to the character B. The equipment items E5 and E6 included in the equipment set S1 are already equipped to the character B; therefore, when the equipment set S1 is selected, it is determined that the equipment items E5 and E6 from among the plurality of equipment items included in the equipment set S1 overlap with the equipment items for the character B. As already mentioned, the above-mentioned overlapping may be determined at a timing other than the timing at which the equipment set S1 is selected from the equipment set list 51.

In this specification, among the equipment items included in the equipment set selected on the equipment set management screen for the character A (for example, the equipment set management screen 50B), those that are already equipped to the character B are referred to as “overlapping equipment items,” and those that are not equipped to the character B are referred to as “non-overlapping equipment items.” In the example shown in FIG. 12, the equipment items E5 and E6 are overlapping equipment items, and the equipment items E9 and E10 are non-overlapping equipment items.

To distinguish the equipment items E5 and E6, which are overlapping equipment items, from the equipment items E9 and E10, which are non-overlapping equipment items, in the configuration item display area 52, the equipment change portion 11c displays an overlapping equipment marker 55 so as to overlap with each of the first display area 52a in which the equipment item E5 is displayed and the second display area 52b in which the equipment item E6 is displayed. The overlapping equipment markers 55 displayed on the equipment set management screen 50B allow the user to know that the equipment items E5 and E6 are overlapped with the equipment for the character B. The overlapping equipment markers 55 may be character display images showing the character B equipped with the equipment items E5 and E6, which are overlapping equipment items. By using character display images showing a character equipped with overlapping equipment items as the overlapping equipment markers 55, the user can be made aware of which characters are equipped with overlapping equipment items even when the user is using three or more characters.

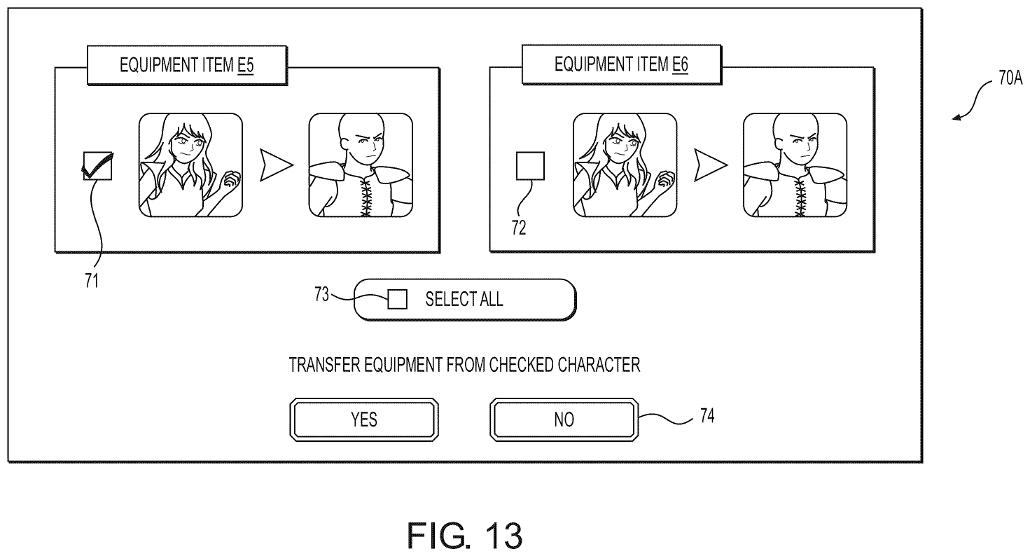

When the selection of the “equip” button 54 is accepted while the equipment set S1 is being selected, the equipment change portion 11c generates a switching setting screen 70A shown in FIG. 13 and displays the generated switching setting screen 70A on the display of the user device 10. The equipment change portion 11c may transition the screen displayed on the display from the equipment set management screen 50B to the switching setting screen 70A. The switching setting screen 70A may be displayed as an overlay on the equipment set management screen 50B.

The user can use the switching setting screen 70A to determine whether to equip the character A or B with the equipment items E5 and E6, which are in a conflicting relationship between the character A and character B. Specifically, the user can instruct, via an operation on an input element included in the switching setting screen 70A, whether (i) to leave each of the equipment items E5 and E6, which are overlapping equipment items, equipped to the character B or (ii) to transfer them from the character B to the character A. More specifically, the switching setting screen 70A includes a check box 71 associated with the equipment item E5 and a check box 72 associated with the equipment item E6. When the check box 71 is checked, it is designated that the equipment item E5 is removed from the equipment for the character B and transferred to the character A. Similarly, when the check box 72 is checked, it is designated that the equipment item E6 is removed from the equipment for the character B and transferred to the character A. When the check box 71 is not checked, it is designated that the equipment item E5 is caused to be equipped to the character B as is and is not caused to be equipped to the character A. Similarly, when the check box 72 is not checked, it is designated that the equipment item E6 is caused to be equipped to the character B as is and is not caused to be equipped to the character A.

The switching setting screen 70A shown in FIG. 13 includes a check box 73 for collective selection that collectively designates the transfer of equipment from the character B to the character A. When the check box 73 is checked, it is designated that all of the overlapping equipment items are transferred from the character B to the character A.

The check boxes 71 to 73 are examples of “second input elements” recited in the scope of the claims. To designate whether to transfer the overlapping equipment items from the character B to the character A, a GUI widget other than the check boxes 71 to 73 may be used.

When the equipment change portion 11c receives the selection of a decision button 74 included in the switching setting screen 70A, it specifies a switching item to be transferred from the character B to the character A from among the overlapping equipment items, according to which of the check boxes 71 to 73 is checked. As shown in FIG. 13, when the check box 71 for the equipment item E5 is checked and the remaining check boxes 72 and 73 are not checked, the equipment item E5 is specified as a switching item. In this case, the equipment item E6 is identified as a non-switching item that is not transferred to the character A.

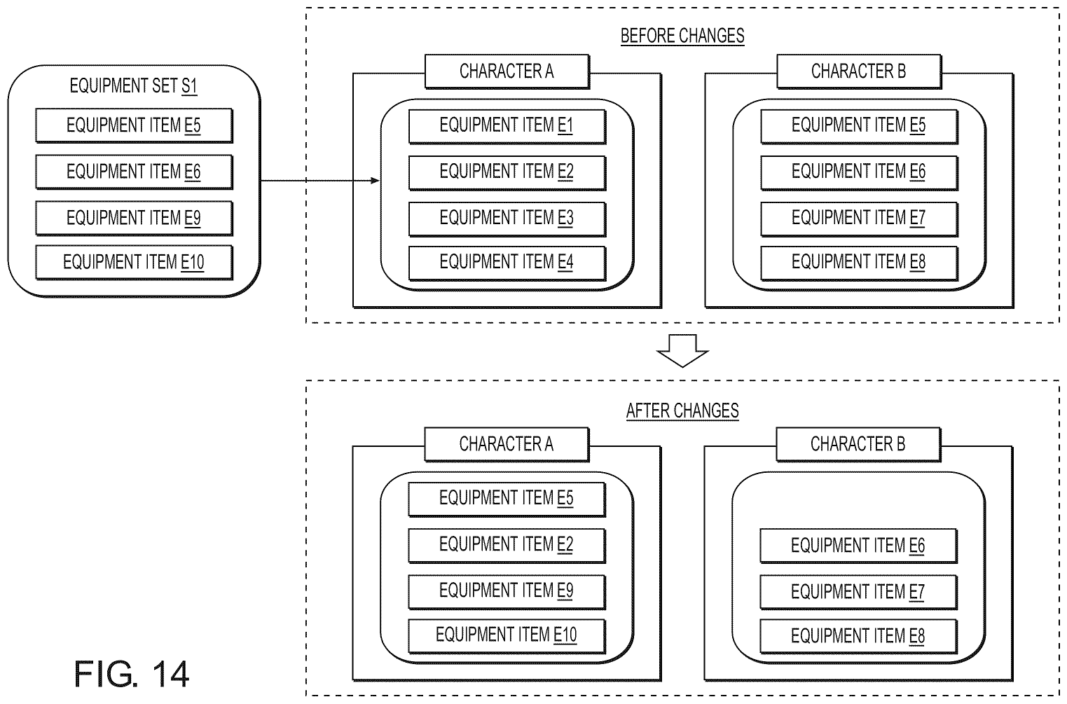

According to the selection of the decision button 74, as shown in FIG. 14, the equipment change portion 11c equips the equipment items E9 and E10, which are non-overlapping equipment items, and also performs a process for transferring the equipment item E5, which is a switching item from among the overlapping equipment items, from the character B to the character A. The equipment item E6, which is a non-switching item from among the overlapping equipment items, is caused to be equipped to the character B as is and is not transferred to the character A. The equipment change portion 11c updates the item IDs stored in association with the characters A and B in the equipment management data 15b so as to reflect the above equipment changes. In the equipment management data 15b that has been updated, the item IDs corresponding to the equipment items E1, E3, and E4 equipped by the character A before the equipment change are deleted. Meanwhile, three item IDs respectively identifying the equipment items E5, E9, and E10 newly equipped to the character A are stored in correspondence with the character ID identifying the character A. Also, the equipment item E5 equipped by the character B before the equipment change has been transferred to the character A. Therefore, in the equipment management data 15b that has been updated, the correspondence between the item ID identifying the equipment item E5 and the character ID for the character B is canceled, and the item ID identifying the equipment item E5 is stored in correspondence with the character ID for the character A. As shown in FIG. 14, because the equipment item E5 has been transferred from the character B to the character A, one of four item setting frames for the character B is vacant. The user can set an equipment item to be equipped to the character B instead of the transferred equipment item ES from, for example, the equipment set management screen for the character B.

The equipment change portion 11c may generate a switching setting screen 70 in a state in which the check box 73 for collectively setting the overlapping equipment items as switching items is checked, in response to the selection of the “equip” button 54 being accepted while the equipment set S1 is being selected. That is, when the “equip” button 54 is selected, a default may be set to transfer all the overlapping equipment items from the character B to the character A. With this default setting, the user's intention that makes the character A be equipped with equipment items included in the equipment set S1 by selecting the equipment set S1 can be reflected in the process for transferring equipment items.

Thus, when the selection of the “equip” button 54 is accepted while the equipment set S1 is being selected on the equipment set management screen 50B, according to instructions from the user via a switching setting screen 70B, the equipment items E9 and E10, which are non-overlapping equipment items, are newly equipped to the character A, and the equipment item E5, which is designated as a switching item from among the overlapping equipment items, is transferred from the character B to the character A. On the other hand, the equipment item E6 that is not designated as a switching item from among the overlapping equipment items continues to be equipped to the character B. Therefore, even when the equipment items for the character A are changed collectively by applying an equipment set, if the selected equipment set includes overlapping equipment items that overlap with equipment items for the character B, by using the switching setting screen 70A, the user can designate whether to transfer each of the overlapping equipment items to the character A or to leave them equipped to the character B as is. This allows the updated equipment for each character to be determined so as to reflect the user's intention, even when updating equipment items collectively using an equipment set.

The equipment change portion 11c can also change the equipment items equipped to the character A individually without using an equipment set. The process for changing the equipment items individually can be performed by appropriately using a known method; therefore, an explanation thereof will be omitted.

### 6. Modified Example

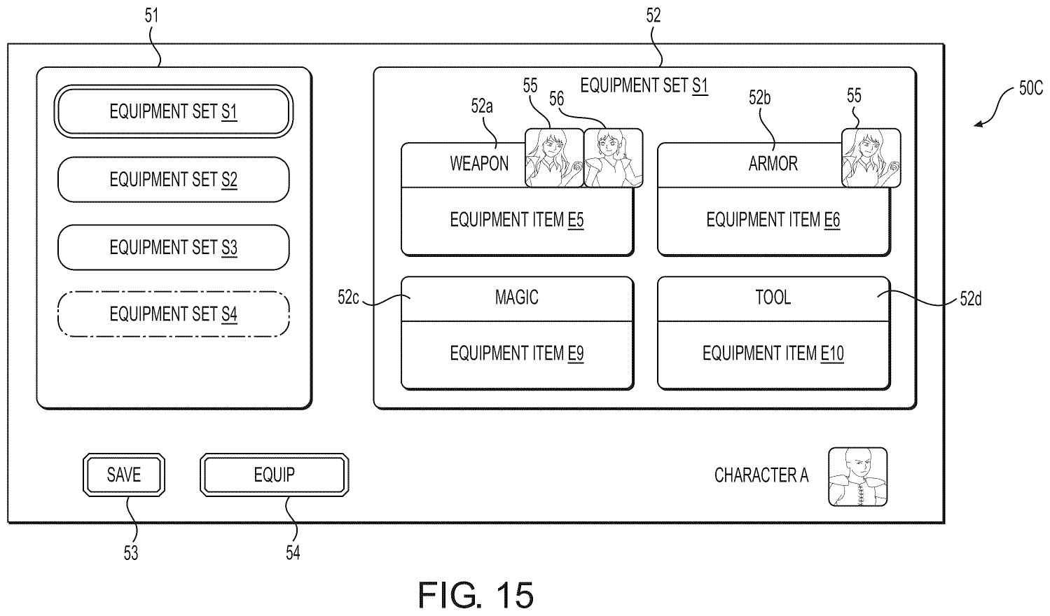

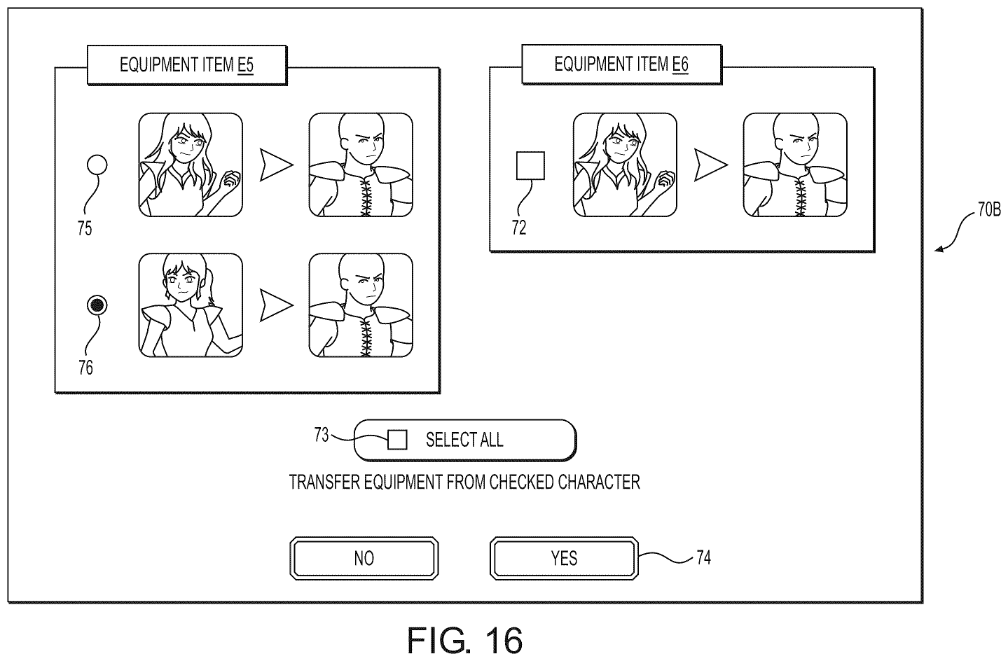

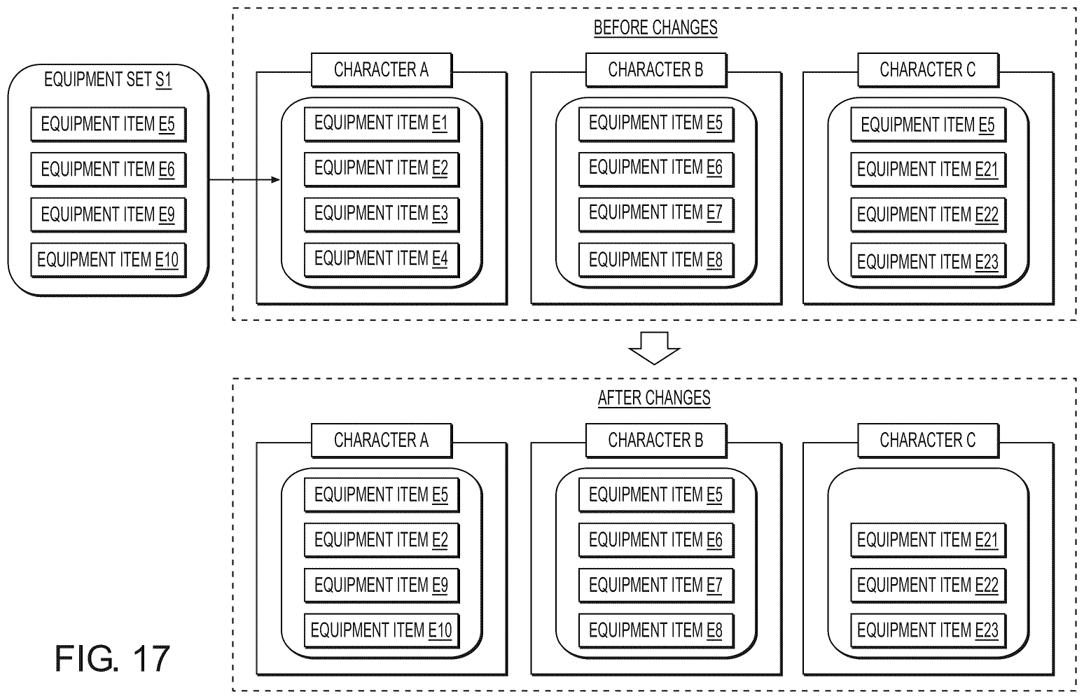

Next, a modified example of the process for changing the equipment items when the equipment set S1 explained with reference to FIGS. 12 to 14 is selected will be explained with reference to FIGS. 15 to 17. FIG. 15 shows an equipment set management screen 50C for the character A that is displayed when the equipment set S1 is selected. FIG. 16 shows the switching setting screen 70B that is displayed when selection of the “equip” button 54 is accepted while the equipment set S1 is being selected on the equipment set management screen 50C. FIG. 17 shows a schematic diagram explaining the process of transferring equipment set items included in equipment set S1. In the example shown in FIGS. 15 to 17, the equipment item E5 is set so as to be able to be equipped to two user characters, which is different from the examples in FIGS. 12 to 14 in which the equipment item E5 can be equipped by only one user character. Also, in the example shown in FIGS. 15 to 17, it is assumed that the user will progress through the game using three characters: characters A, B, and C. As shown in FIG. 17, before the process for applying the equipment set is performed, the character A is equipped with the equipment items E1 to E4, the character B is equipped with the equipment items E5 to E8, and the character C is equipped with the equipment item E5 and the equipment items E21 to E23. Therefore, the equipment item E5 is equipped to two characters (that is, the characters B and C). In FIGS. 15 to 17, elements corresponding to those shown in FIGS. 12 to 14 are given the same reference numerals as in FIGS. 12 to 14. Hereinafter, detailed explanations of elements already explained with reference to FIGS. 12 to 14 will be omitted as appropriate.

In the equipment set management screen 50C for the character A shown in FIG. 15, when the equipment set S1 is selected from the equipment set list 51, the equipment items E5, E6, E9, and E10 included in the equipment set S1 are displayed in the configuration item display area 52. Additionally, in response to the acceptance of the selection of the equipment set S1, it is determined whether the equipment items E5, E6, E9, and E10 included in the equipment set S1 overlap with (i) the equipment items E5 to E8 equipped to the character B or (ii) the equipment items E5, E21 to E23 equipped to the character C. The equipment items E5 and E6 included in the equipment set S1 are already equipped to the character B. Therefore, when the equipment set S1 is selected, it is determined that the equipment items E5 and E6 from among the plurality of equipment items included in the equipment set S1 overlap with the equipment items for the character B. Additionally, the equipment item E5 included in the equipment set S1 is also equipped to the character C. Therefore, it is determined that the equipment item E5 from among the plurality of equipment items included in the equipment set S1 overlaps with the equipment item of the character C.

To distinguish the equipment items E5 and E6, which are overlapping equipment items, from the equipment items E9 and E10, which are non-overlapping equipment items, in the configuration item display area 52, the equipment change portion 11c displays the overlapping equipment markers 55 and an overlapping equipment marker 56 so as to overlap with the first display area 52a in which the equipment item E5 is being displayed and the second display area 52b in which the equipment item E6 is being displayed. The overlapping equipment markers 55 may be character display images showing the character B equipped with the equipment items E5 and E6, which are overlapping equipment items. Furthermore, the overlapping equipment marker 56 may be a character display image showing the character C equipped with the equipment item E5, which is an overlapping equipment item. By using the character display images showing the characters equipped with the overlapping equipment items as the overlapping equipment markers 55, 56, the user can know which characters are equipped with the overlapping equipment items.

When the selection of the “equip” button 54 is accepted while the equipment set S1 is being selected, the equipment change portion 11c generates the switching setting screen 70B shown in FIG. 16 and displays the generated switching setting screen 70B on the display of the user device 10. The user can use the switching setting screen 70B to determine which character(s) will be equipped with the equipment item E5 that is in a conflicting relationship among the characters A, B, and C. Specifically, the switching setting screen 70B includes radio buttons 75, 76 associated with the equipment item E5. When the radio button 75 is selected, it is designated that the equipment item E5 is to be removed from the character B and transferred to the character A. Similarly, when the radio button 76 is selected, it is designated that the equipment item E5 is to be removed from the character C and transferred to the character A. When neither the radio button 75 nor 76 is checked, it is designated that the equipment item E5 is to remain equipped to the characters B and C, but is not to be equipped to the character A.

The radio buttons 75 and 76 are examples of “second input elements” recited in in the scope of the claims. A GUI widget other than the radio buttons 75 and 76 may be used to designate whether to transfer the overlapping equipment items from the character B to the character A.

When the equipment change portion 11c accepts the selection of the decision button 74 included in the switching setting screen 70A, it specifies a switching item to be transferred from the character B to the character A among the overlapping equipment items according to which of the radio buttons 75, 76 and the check boxes 72, 73 are checked. As shown in FIG. 16, when the radio button 76 is checked and the check box 72 is not checked, the equipment item E5 equipped to the character C is specified as a switching item. In this case, the equipment items E5 and E6 equipped to the character B are specified as non-switching items that are not transferred to the character A.

As shown in FIG. 17, according to the selection of the decision button 74, the equipment change portion 11c equips the equipment items E9 and E10, which are non-overlapping equipment items, and also performs a process for transferring the equipment item E5, which is a switching item among the overlapping equipment items, from the character C to the character A. Among the overlapping equipment items, the equipment items E5 and E6 equipped to the character B are non-switching items and therefore remain equipped to the character B. The equipment change portion 11c updates the item IDs stored in association with the characters A, B, and C in the equipment management data 15b so as to reflect the above equipment changes.

The equipment change portion 11c may generate the switching setting screen 70 in a state in which the check box 73 for collectively setting the overlapping equipment items as switching items is checked according to the selection of the “equip” button 54 being accepted while the equipment set S1 is being selected. That is, when the “equip” button 54 is selected, a default setting may be to transfer all the overlapping equipment items from the character B to the character A. With this default setting, the user's intention to equip the character A with equipment items included in the equipment set S1 by selecting equipment set S1 can be reflected in the process for transferring the equipment items.

As described above, when the selection of the “equip” button 54 is accepted while the equipment set S1 is being selected on the equipment set management screen 50C, in response to instructions from the user via the switching setting screen 70B, the equipment items E9 and E10, which are non-overlapping items, are newly equipped to the character A, and also, the equipment item E5, which is designated as a switching item from among the overlapping equipment items, is transferred from the character C to the character A. On the other hand, the equipment items E5 and E6 equipped to the character B that were not designated as switching items from among the overlapping equipment items will continue to be equipped to the character B.

When transferring the equipment item E5 from the character B, not the character C, to the character A, the radio button 75 may be selected instead of the radio button 76 on the switching setting screen 70B. Additionally, when the check box 72 is selected, the equipment item E6 also becomes a switching item. In this case, the equipment item E6 is transferred from the character B to the character A.

Therefore, even when the equipment items of the character A are collectively changed by applying an equipment set, if the selected equipment set includes overlapping equipment items that overlap with the equipment items of the character B or C, by using the switching setting screen 70B, the user can designate whether to transfer each of the overlapping equipment items to character A, or to leave them equipped to the character B or character C as is. Additionally, for the equipment item E5 equipped to both the characters B and C, the user can select whether either the equipment item E5 equipped to the character B or the equipment item E5 equipped to the character C will be transferred to the character A according to the selection of the user. Therefore, even when equipment items are updated collectively using an equipment set, the updated equipment for each character can be determined to reflect the user's intention.

### 7. Process Flow

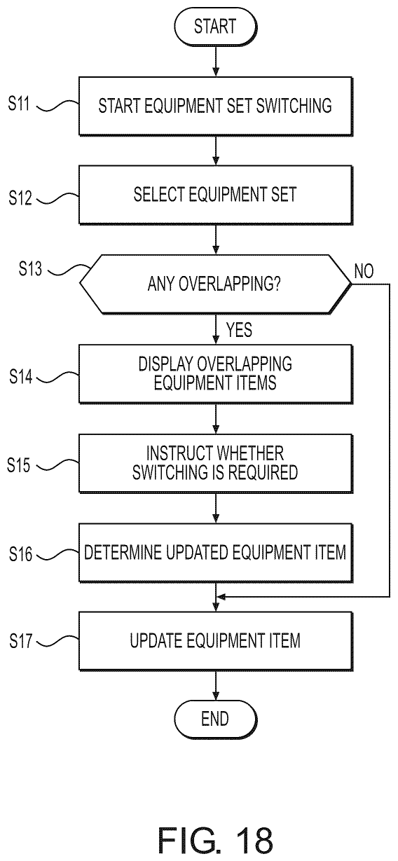

Next, a process for changing an equipment item using an equipment set will be explained with reference to FIG. 18. A process flow in FIG. 18 shows a process for changing an equipment item schematically shown in FIG. 14 as a series of process flow. FIG. 18 is a flowchart explaining a general flow of a process for updating an equipment item using an equipment set. In the update process shown in FIG. 18, it is assumed that the user is playing the game using the characters A and B, and updates the equipment items for the character A by selecting either equipment set S1 or S2 as shown in FIG. 2.

First, in step S11, a process for changing an equipment item using an equipment set is started. The process for changing an equipment item is started, for example, by displaying the equipment set management screen 50A on the display of the user device 10 according to a user operation while playing a game.

When the equipment set management screen 50A is displayed in step S11, the process for changing an equipment item proceeds to step S12. In step S12, one equipment set is selected from the equipment set list 51 according to an operation on the user device 10 by the user.

When an equipment set is selected in step S12, the process for changing an equipment item proceeds to step S13. In step S13, it is determined whether the equipment items included in the equipment set selected in step S12 overlap with the equipment items for the character B. If the equipment set S2 is selected in step S12, the equipment items included in the equipment set S2 do not overlap with the equipment items for the character B; therefore, in response to the “equip” button 54 being selected, the process for changing an equipment item proceeds to step S17. In step S17, the equipment items E11 to E14 included in the equipment set S2 are newly equipped to the character A. That is, the equipment for the character A is changed to the equipment items E11 to E14 included in the equipment set S2.

On the other hand, if the equipment set S1 is selected in step S12, the equipment items E5 and E6 from among the plurality of equipment items included in the equipment set S1 overlap with the equipment items for the character B; therefore, the process for changing an equipment item proceeds to step S14. In step S14, the overlapping equipment markers 55 are displayed in association with the overlapping equipment items on the equipment set management screen 50B so that the overlapping equipment items (that is, the equipment items E5 and E6) can be distinguished from non-overlapping equipment items. The user can be informed by the overlapping equipment marker 55 that equipment items E5 and E6 of the equipment items included in the selected equipment set S1 are already equipped to the character B. After the overlapping equipment markers 55 are displayed, in response to the “equip” button 54 being selected, the process for changing an equipment item proceeds to step S15.

In step S15, the switching setting screen 70 is displayed on the display of the user device 10. The user indicates which of the overlapping equipment items to transfer to the character A by selecting any of the check boxes 71 to 73 included in the switching setting screen 70, or by not selecting any of them.

In step S16, a switching item is specified from among the overlapping equipment items according to the instruction in step S15. For example, in the example shown in FIG. 13, since only the check box 71 for transferring the equipment item E5 is checked, the equipment item E5 is specified as a switching item, and the equipment item E6 is specified as a non-switching item. In response to the decision button 74 being selected on the switching setting screen 70, the process for changing an equipment item proceeds to step S17. In step S17, from among the equipment items E5, E6, E9, and E10 included in the equipment set S1, the equipment items E9 and E10, which are non-overlapping equipment items, and the equipment item E5, which is specified as a switching item among the overlapping equipment items, are newly equipped to the character A. That is, the equipment for the character A is changed to the equipment items E5, E9, and E10, which are part of the plurality of equipment items included in the equipment set S1.

When the equipment items for the character A are updated in step S17, the equipment management data 15b is updated to reflect the change in the equipment items for the character A.

As a result, the equipment items for the character A are collectively changed using the equipment set.

### 8. Commentary

The game system 1 shown in FIG. 1 is an example of a system to which this disclosure can be applied. The game system is not limited to that shown in FIG. 1. The game system 1 may not include some of the components shown in the figure. For example, the game system 1 may not include the storage 30. The game system 1 may include components that are not shown in the figure. Although only one user device 10 is shown in FIG. 1 for simplicity of explanation, the game system 1 may include any number of two or more user devices 10. The game system 1 may include a cloud environment for distributing and processing the processes to be executed by the user devices 10 or the server 20.

In the game system 1, there are no particular restrictions on the storage location of data. For example, various data that can be stored in the storage 15 may be stored in a storage that is physically separate from the storage 15 (for example, the storage 30) or in a database server. In this specification, data explained as being stored in the storage 15 may be stored in a single storage, or may be distributed and stored in a plurality of storages. Additionally, in this specification and the scope of the claims, simply “storage” may also refer to either a single storage or a collection of plurality of storage, as the context allows. The above explanation regarding data that can be stored in the storage 15 also applies as much as possible to data stored in the storage 25.

The embodiments are not limited to the embodiments described above, and various modifications can be made without departing from the object thereof. For example, part or all of the functions executed by the processors 11 and 21 may be realized by a processor not specified in this specification, unless it departs from the object of the disclosure. The processor 11 is shown as a single component in FIG. 1, but the processor 11 may be a collection of a plurality of physically separate processors. The same applies to the processor 21. In this specification, the programs explained as being executed by the processors 11 and 21 or the commands included in the programs may be executed by a single processor or may be executed in a distributed manner by a plurality of processors. Additionally, the programs executed by the processors 11 and 21 or the commands included in the programs may be executed by one or more virtual processors.

The programs executed by the processor 11 and/or processor 21 may be stored in various types of non-transitory computer readable media in addition to the storage shown in the figures. Non-transitory computer-readable media includes various types of tangible storage media. Examples of non-transitory computer-readable media include magnetic recording media (for example, flexible disks, magnetic tape, hard disk drives), magneto-optical recording media (for example, magneto-optical disks), Compact Disc Read Only Memory (CD-ROM), CD-R, CD-R/W, semiconductor memory (for example, mask ROM, Programmable ROM (PROM), Erasable PROM (EPROM), flash ROM, and Random Access Memory (RAM)).

The functions that are realized by the components described in this specification may be implemented in circuitry or processing circuitry, including general purpose processors, special purpose processors, integrated circuits, ASICs (Application Specific Integrated Circuits), a CPU (Central Processing Unit), conventional circuits, and/or combinations thereof, programmed to realize the functions described. A processor includes transistors and other circuits and is considered circuitry or processing circuitry. The processor may be a programmed processor that executes a program stored in memory.

In this specification, circuitry, portion, and means are hardware that is programmed to realize the functions described or hardware to execute the functions described. The hardware may be any hardware disclosed in this specification or programmed to realize the functions described or known to realize the described functions. If the hardware is a processor considered to be a type of circuitry, the circuitry, means or portion is a combination of hardware and software used to configure the hardware and/or processor.

Even if the processes and procedures described in this specification are explained as being executed by a single device, software, component, or module, such processes or procedures may be executed by a plurality of devices, software, components, and/or modules. Furthermore, even if the data, tables, or databases explained in this specification are explained as being stored in a single memory, such data, tables, or databases may be distributed and stored in a plurality of memories included in a single device or distributed and arranged across a plurality of devices. Additionally, the software and hardware elements explained in this specification can be realized by integrating them into fewer components or decomposing them into more components.

In the processing procedures explained in this specification, particularly in the processing procedures explained using a flowchart or sequence diagram, it is possible to omit some of the steps constituting the processing procedure, to add a step that is not specified as a step constituting the processing procedure, and/or to change the order of the steps, and such omissions, additions, and changes in the order of the processing procedures are also included in the scope of this disclosure as long as they do not depart from the object of this disclosure.

Notations such as “first,” “second,” “third,” and the like in this specification and the scope of the claims are used to identify components, and do not necessarily limit the number, order, or content. Additionally, numbers for identifying components are used in each context, and a number used in one context does not necessarily show the same configuration in another context. Additionally, a component identified by a certain number does not preclude the component from also having the function of a component identified by another number.

### 9. Notes In this specification, techniques in the following paragraphs are also disclosed.

### Note 1

A game system in which a user progresses through a game using a plurality of characters including a first character (A) and one or more other characters (B, C) different from the first character, comprising:
one or more processors (11); and
a storage (15, 15c) that stores a first equipment set (S1) associated with a plurality of equipment items (E5, E6, E9, E10), wherein:
the one or more processors display, on a user device (10) of the user, set item information (52) showing each of the plurality of equipment items associated with the first equipment set, an overlapping equipment marker (55) for distinguishing one or more overlapping equipment items equipped to any of the one or more other characters from among the plurality of equipment items from non-overlapping equipment items not equipped to any of the one or more other characters, and a first input element (54) for applying the first equipment set to the first character; and in response to the selection of the first input element, at least one (E5, E9, E10) of the plurality of equipment items is caused to be equipped to the first character.

### Note 2

The game system according to note 1, wherein:
the one or more other characters include a second character equipped with at least one of the one or more overlapping equipment items; and
the overlapping equipment marker is character display information showing the second character.

### Note 3

The game system according to note 1 or 2, wherein:
the one or more other characters include a second character equipped with at least one of the one or more overlapping equipment items; and
the one or more processors cause the user device of the user to display a second input element (71-73) for designating whether to transfer each of the one or more overlapping equipment items equipped by the second character from the second character to the first character.

### Note 4

The game system according to note 3, wherein:
the one or more processors, in response to an input to the second input element, specify a switching item to be transferred to the first character from among the one or more overlapping equipment items, and cause the switching item to be equipped to the first character.

### Note 5

The game system according to note 4, wherein:
from among the plurality of equipment items, a non-overlapping equipment item other than the overlapping equipment item is caused to be equipped to the first character together with the switching item.

### Note 6

The game system according to note 4, wherein:
the one or more processors do not equip the first character with a non-switching item other than the switching item from among the one or more overlapping equipment items.

### Note 7

The game system according to note 4, wherein:
the one or more processors exclude the switching item from equipment of the one or more other characters.

### Note 8

The game system according to note 4, wherein:
the one or more processors set all of the one or more overlapping equipment items to the switching items in response to an input to the first input element.

### Note 9

The game system according to note 8, wherein:
the one or more processors change the switching item to a non-switching item other than the switching item from among the one or more overlapping equipment items in response to an operation on the second input element corresponding to the switching item.

### Note 10

The game system according to any of notes 1-9, wherein:
the one or more processors make available a second equipment set (51d) different from the first equipment set according to a parameter related to the game.

### Note 11

The game system according to note 10, wherein:
the storage further stores the second equipment set; and
the second equipment set is associated with a plurality of other equipment items different from the plurality of equipment items.

### Note 12

The game system according to note 3, wherein:
the one or more other characters include a third character equipped with at least one of the one or more overlapping equipment items; and
the one or more processors cause the user device of the user to display a third input element (76) for designating whether to transfer each of the one or more overlapping equipment items equipped to the third character from the third character to the first character.

### Note 13

A game processing method in which a user progresses through a game using a plurality of characters including a first character and one or more other characters different from the first character, the game processing method being executed by one or more processors, the game processing method comprising the steps of: displaying, on a user device of the user, set item information showing each of the plurality of equipment items associated with a first equipment set, an overlapping equipment marker for distinguishing one or more overlapping equipment items equipped to any of the one or more other characters from among the plurality of equipment items from non-overlapping equipment items not equipped to any of the one or more other characters, and a first input element for applying the first equipment set to the first character; and
equipping at least one of the plurality of equipment items to the first character in response to the selection of the first input element.

### Note 14

A game program in which a user progresses through a game using a plurality of characters including a first character and one or more other characters different from the first character, the game program causing one or more processors to execute the steps of:
displaying, on a user device of the user, set item information showing each of the plurality of equipment items associated with a first equipment set, an overlapping equipment marker for distinguishing one or more overlapping equipment items equipped to any of the one or more other characters from among the plurality of equipment items from non-overlapping equipment items not equipped to any of the one or more other characters, and a first input element for applying the first equipment set to the first character; and
equipping at least one of the plurality of equipment items to the first character in response to the selection of the first input element.

### Explanation of Symbols

1 Game system
10 User device
11a Game progression portion
11b Equipment set management portion
11c Equipment change portion
15 Storage
15a Game application
15b Equipment management data
15c Equipment set data
20 Server
50A-50C Equipment set management screens
55, 56 Overlapping equipment marker
60 Equipment item change window
70A, 70B Switching setting screens

1. A game system in which a user progresses through a game using a plurality of characters including a first character and one or more other characters different from the first character, the game system comprising:
one or more processors; and
a storage that stores a first equipment set associated with a plurality of equipment items, wherein
the one or more processors are programmed to display, on a user device of the user, set item information showing each of the plurality of equipment items associated with the first equipment set, an overlapping equipment marker for distinguishing one or more overlapping equipment items equipped to any of the one or more other characters from among the plurality of equipment items from non-overlapping equipment items not equipped to any of the one or more other characters, and a first input element for applying the first equipment set to the first character, and
in response to selection of the first input element, at least one of the plurality of equipment items is caused to be equipped to the first character.

2. The game system according to claim 1, wherein
the one or more other characters include a second character equipped with at least one of the one or more overlapping equipment items, and
the overlapping equipment marker is character display information showing the second character.

3. The game system according to claim 1, wherein
the one or more other characters include a second character equipped with at least one of the one or more overlapping equipment items, and
the one or more processors cause the user device of the user to display a second input element for designating whether to transfer each of the one or more overlapping equipment items equipped by the second character from the second character to the first character.

4. The game system according to claim 3, wherein
the one or more processors, in response to an input to the second input element, specify a switching item to be transferred to the first character from among the one or more overlapping equipment items, and cause the switching item to be equipped to the first character.

5. The game system according to claim 4, wherein
from among the plurality of equipment items, a non-overlapping equipment item is caused to be equipped to the first character together with the switching item.

6. The game system according to claim 4, wherein
the one or more processors do not equip the first character with a non-switching item other than the switching item from among the one or more overlapping equipment items.

7. The game system according to claim 4, wherein
the one or more processors exclude the switching item from equipment of the one or more other characters.

8. The game system according to claim 4, wherein
the one or more processors set all of the one or more overlapping equipment items to the switching items in response to an input to the first input element.

9. The game system according to claim 8, wherein
the one or more processors change the switching item to a non-switching item other than the switching item from among the one or more overlapping equipment items in response to an operation on the second input element corresponding to the switching item.

10. The game system according to claim 1, wherein
the one or more processors make available a second equipment set different from the first equipment set according to a parameter related to the game.

11. The game system according to claim 10, wherein
the storage further stores the second equipment set, and the second equipment set is associated with a plurality of other equipment items different from the plurality of equipment items.

12. The game system according to claim 3, wherein
the one or more other characters include a third character equipped with at least one of the one or more overlapping equipment items, and
the one or more processors cause the user device of the user to display a third input element for designating whether to transfer each of the one or more overlapping equipment items equipped by the third character from the third character to the first character.

13. A game processing method in which a user progresses through a game using a plurality of characters including a first character and one or more other characters different from the first character, the game processing method being executed by one or more processors, the game processing method comprising:
displaying, on a user device of the user, set item information showing each of a plurality of equipment items associated with a first equipment set, an overlapping equipment marker for distinguishing one or more overlapping equipment items equipped to any of the one or more other characters from among the plurality of equipment items from non-overlapping equipment items not equipped to any of the one or more other characters, and a first input element for applying the first equipment set to the first character; and
equipping at least one of the plurality of equipment items to the first character in response to selection of the first input element.

14. A non-transitory computer-readable medium storing thereon a game program in which a user progresses through a game using a plurality of characters including a first character and one or more other characters different from the first character, the game program causing one or more processors to execute:
displaying, on a user device of the user, set item information showing each of a plurality of equipment items associated with a first equipment set, an overlapping equipment marker for distinguishing one or more overlapping equipment items equipped to any of the one or more other characters from among the plurality of equipment items from non-overlapping equipment items not equipped to any of the one or more other characters, and a first input element for applying the first equipment set to the first character; and
equipping at least one of the plurality of equipment items to the first character in response to selection of the first input element.
